(19) United States
(12) Patent Application Publication
(10) Pub. No.: US 2008/0040135 A1
(43) Pub. Date: Feb. 14, 2008

(54) Process for creating management charts

(76) Inventors: Frank J. VanLangen, Indialantic, FL (US); Steve P. Grant, Melbourne, FL (US)

Correspondence Address: LOUIS L. DACHS, 1794 PALISADES DRIVE, PACIFIC PALISADES, CA, 90272, US

(21) Appl. No.: 11/503,619

(22) Filed: Aug. 14, 2006

(51) Int. Cl. G06Q 10/00; G06Q 30/00

(52) U.S. Cl. 705/1

(57) ABSTRACT

The invention is a process for managing organizational information and resources using a database management program, the process comprising the steps of: 1) defining the organization structure; 2) defining the attributes available for personnel in the structure; 3) entering the personnel attributes into the database; 4) creating and maintaining a set of report criteria that allow for dynamically selected and conditionally formatted attributes to be made into a management organization chart; and 5) using those report criteria to generate real-time organization charts for review.

### BACKGROUND OF THE INVENTION

1. Field of the Invention

The invention relates to the field of organization management computer programs and, in particular, to a process for virtual organization management that provides a manager with a real time view of the organization under his or her control, providing for the identification of personnel and organizational attributes at a glance.

2. Description of Related Art

In the past, in order to develop and track employees using organization charts, the charts had to be prepared using chart preparation programs such as Microsoft Corporation's Power Point™ or Visio™ computer programs. This was accomplished by the manual entering and formatting of data. Thus they were cumbersome to maintain and prone to errors. Secondly, these programs do not provide the ability to easily define employee attributes. This includes user entered attributes (e.g. hire date), calculated attributes (e.g. years of service based on hire date and today's date), and attributes from external systems (e.g. hours of overtime worked this year from a timekeeping system). They do not provide the ability to run an organizational style chart for user selected attributes with on-demand, user defined color coding and definition of attributes at run time.

Thus, it is a primary object of the invention to provide the ability to easily define, maintain, and report employee attributes and the attributes of the organization in which they work.

It is another primary object of the invention to provide the ability to run an organizational style chart for multiple user selected attributes with on-demand, user defined coding and definition of attributes.

It is a still further object of the invention to provide the ability to save report definitions, retrieve these definitions, and share them with other users.

It is a still further object of the invention to provide the ability to define functions that operate on data and/or attributes and then uses these functions as report attributes.

### SUMMARY OF THE INVENTION

The invention is a process for preparing organizationally driven charts and reports using a database management program. The process comprising the steps of:

1. Defining the management organization chart structure.

2. Entering personnel attributes into the database management system, including the distribution of personnel in the organization.

3. Defining the data attributes available to the system, whether these are based upon entered or derived data; and

4. Defining, saving, and retrieving organization chart report definitions that report the requested information, including multiple attribute selection, color coding selection for each attribute, and report style selection.

The process makes use of a commercially available data base management computer program from Oracle Systems (Redwood Shores, Calif.) to store and maintain a user-defined organization structure, employee data, information about how employees fit within the structure, and other data on the individual. Various input forms allow data to be managed by users who are granted access to the variety of modules within the system

The advantages of the process include:

1. The ability to easily define employee attributes. This includes user entered attributes (e.g. hire date), calculated attributes (e.g. years of service based on hire date and today's date), and attributes from external systems (e.g. hours of overtime worked this year from a timekeeping system).

2. The ability to run an organizational style chart for user selected attributes with on-demand, user defined color coding and definition of attributes at run time.

3. The ability to run other charts and reports based upon the accumulated data and defined attributes. These include, but are not limited to, demographic reports, project activity summaries, employee activity summaries (e.g. promotions in a given year), data extracts into 3^{rd} party tools such as Microsoft Excel™. and interactive dashboards.

3. The ability to have an employee occupy a primary position in the organization, but is loaned into other departments and/or act in more than one position.

The novel features which are believed to be characteristic of the invention, both as to its organization and method of operation, together with further objects and advantages thereof, will be better understood from the following description in connection with the accompanying drawings in which the presently preferred embodiment of the invention is illustrated by way of example. It is to be expressly understood, however, that the drawings are for purposes of illustration and description only and are not intended as a definition of the limits of the invention.

### BRIEF DESCRIPTION OF THE DRAWINGS

FIG. 1 is a flow chart of the process for preparing a management organization chart.

FIGS. 2A, 2B, 2C and 2D are a copy of a typical management organization chart.

FIGS. 3A, 3B, 3C and 3D are a computer screen for entering organizational structure.

FIGS. 4A, 4B, 4C, and 4D are a computer screen for entering available attributes.

FIGS. 5A, 5B, 5C and 5D, are a computer screen for entering each employee's attribute data, assigning personnel to groups, and defining their roles in the organization.

FIGS. 6A, 6B, 6C and 6D are a computer screen for defining, saving, and retrieving a specific chart to be created. This includes selecting attributes to be included and highlighting personnel attributes on the management organization chart based upon selected criteria.

### DESCRIPTION OF THE PREFERRED EMBODIMENT

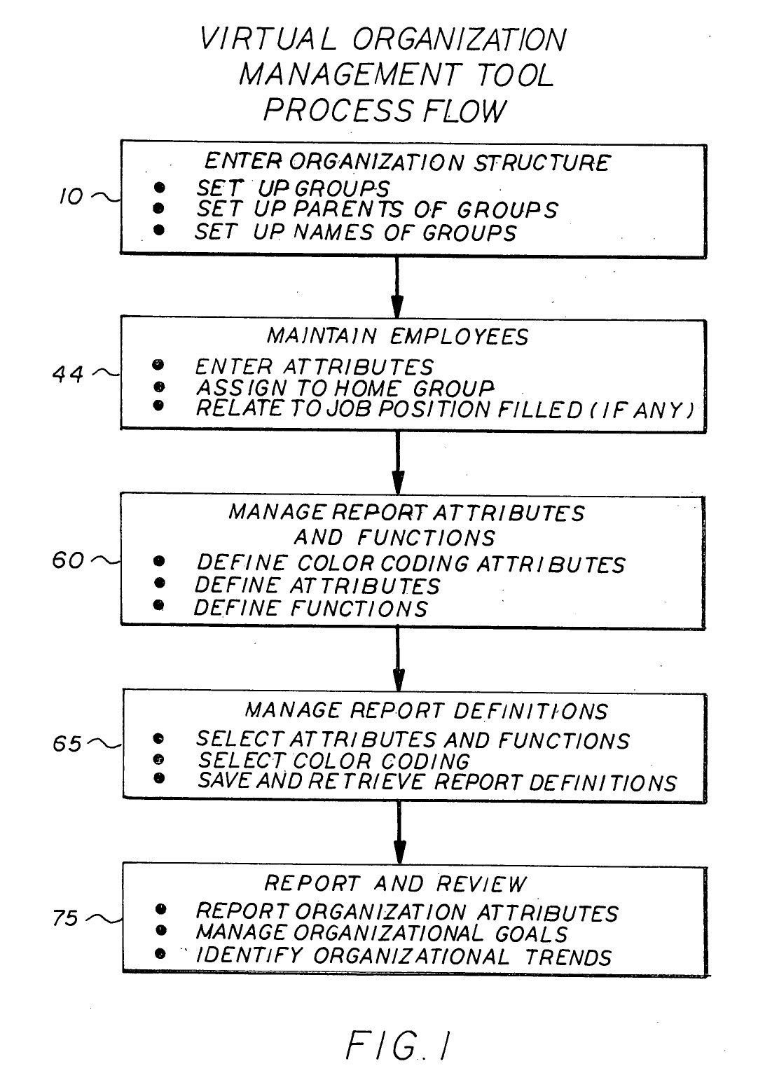

FIG. 1 illustrates the flow chart of the process used to prepare management organization charts. It makes use of a database management computer program, such as the one commercially provided by Oracle Corporation, a set of forms to enter the data, and a set of reports to extract the data.

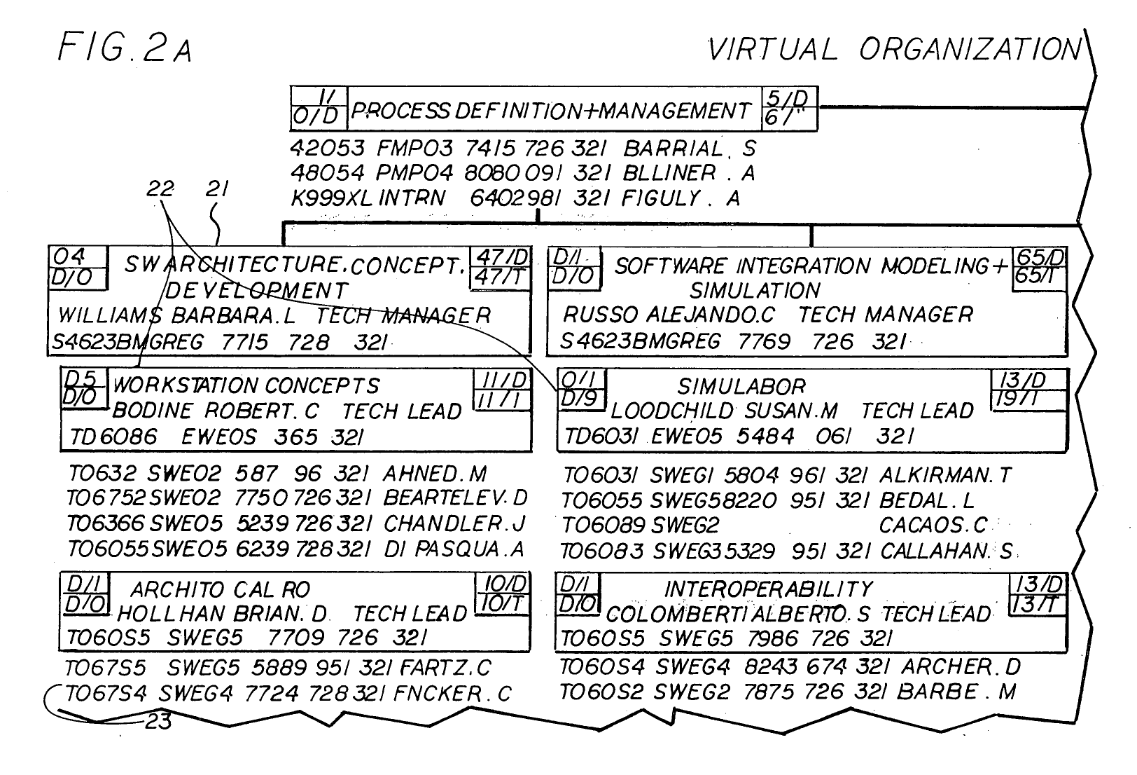

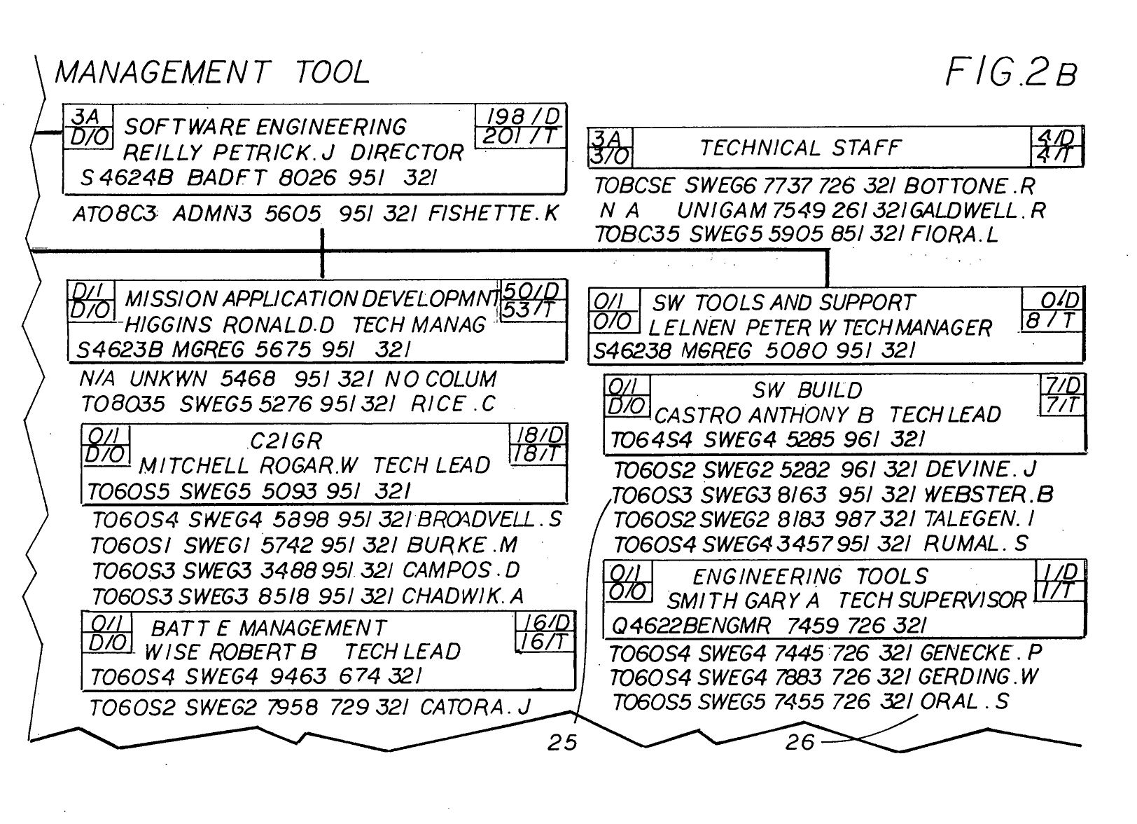

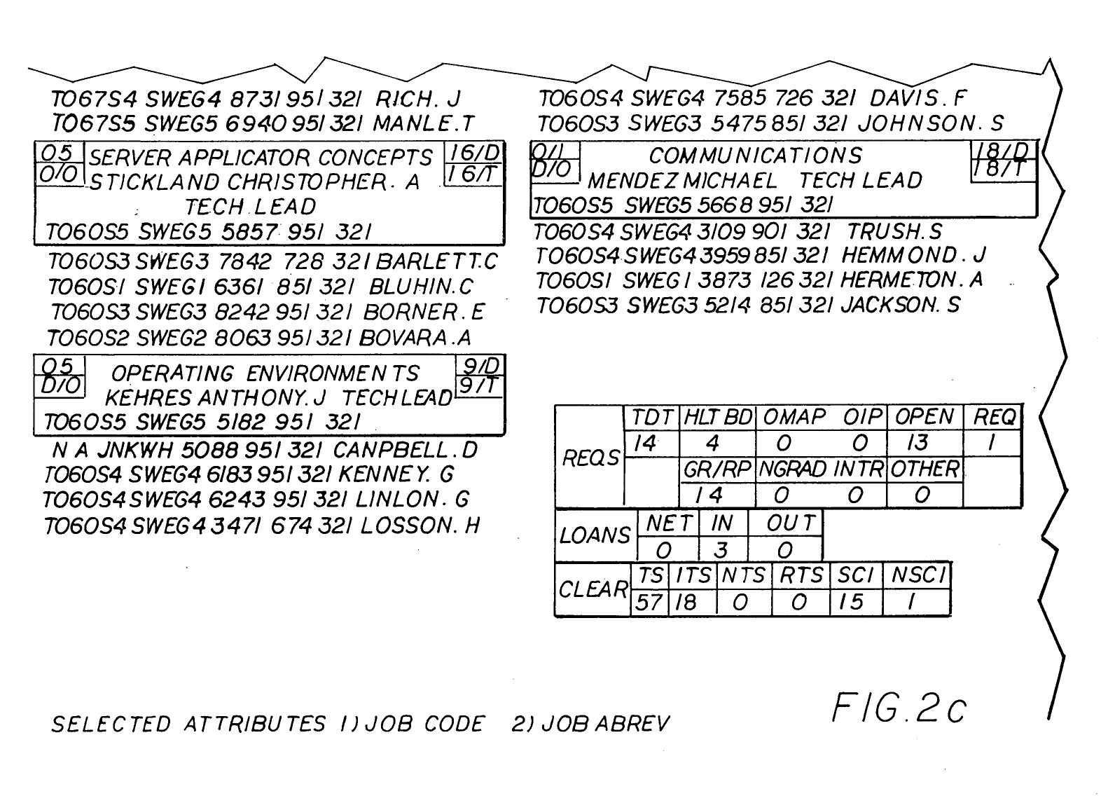

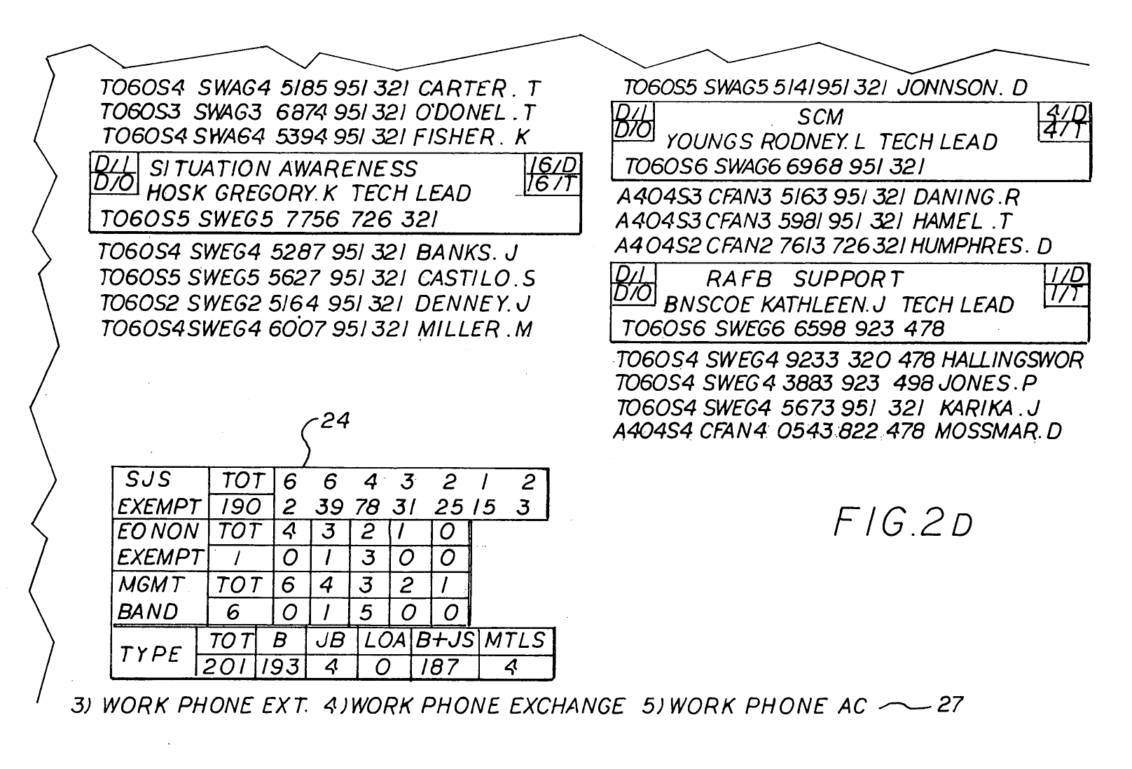

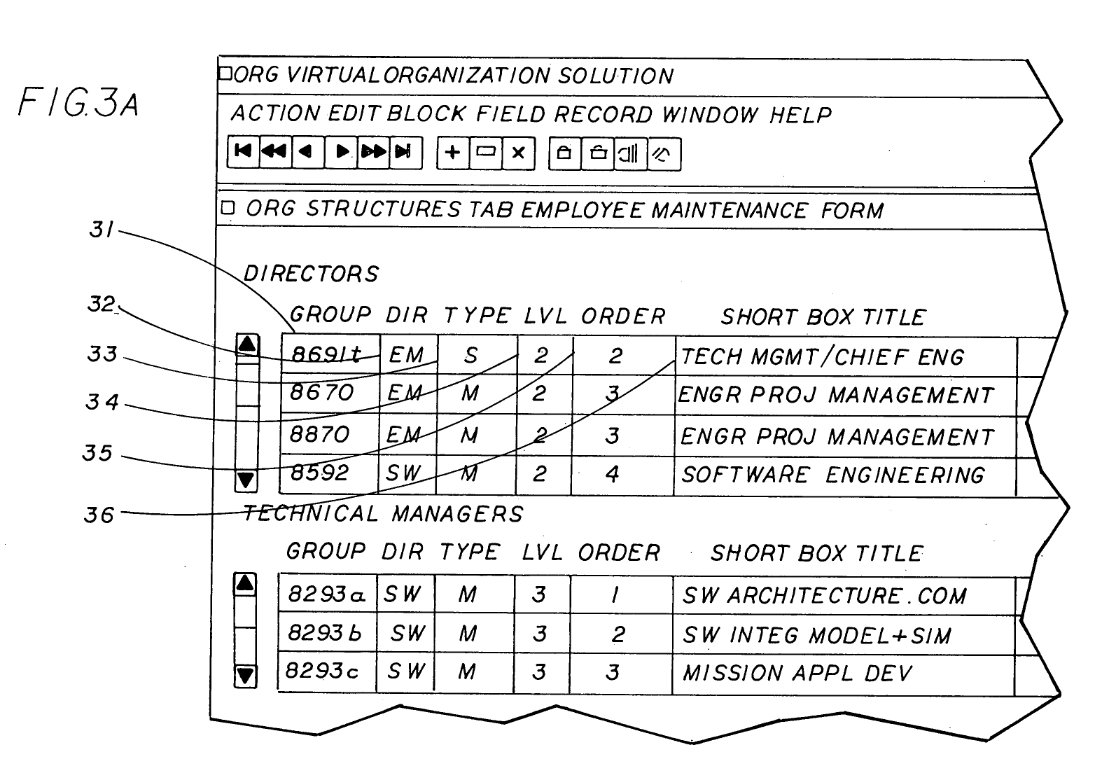

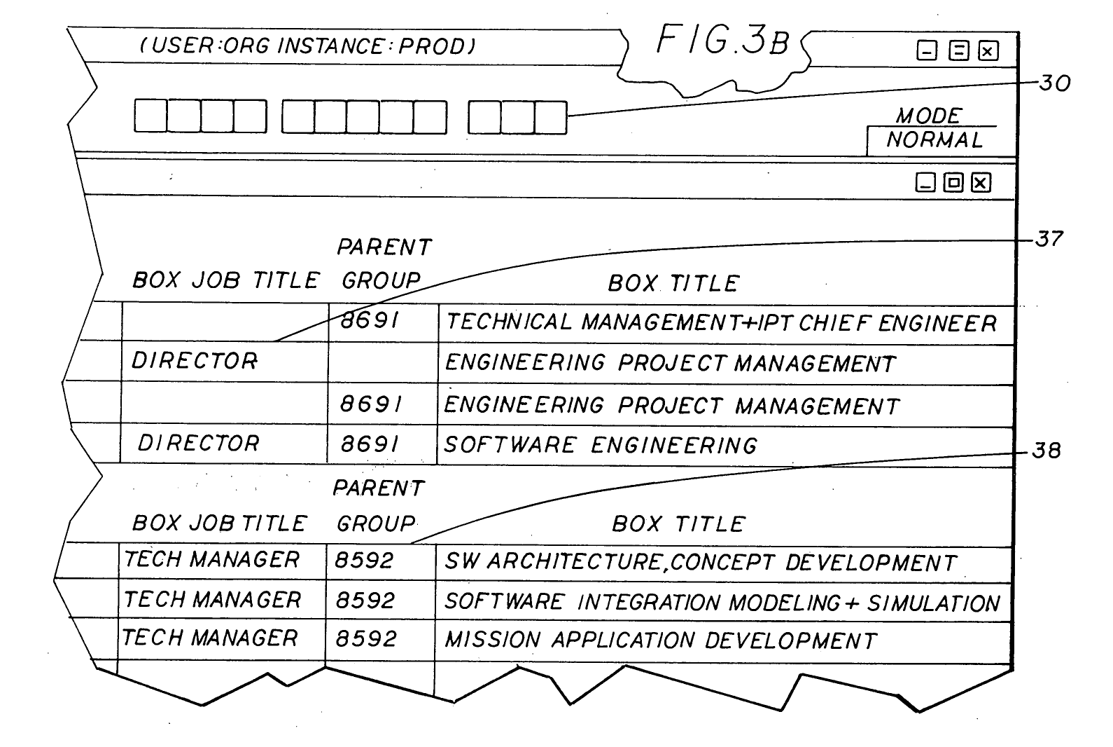

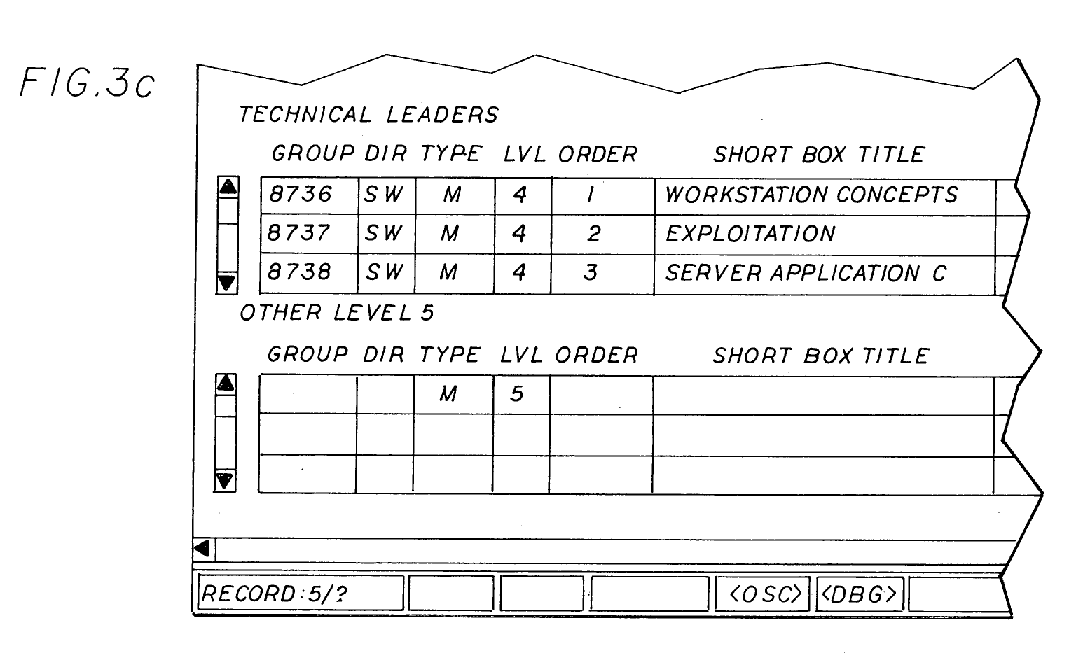

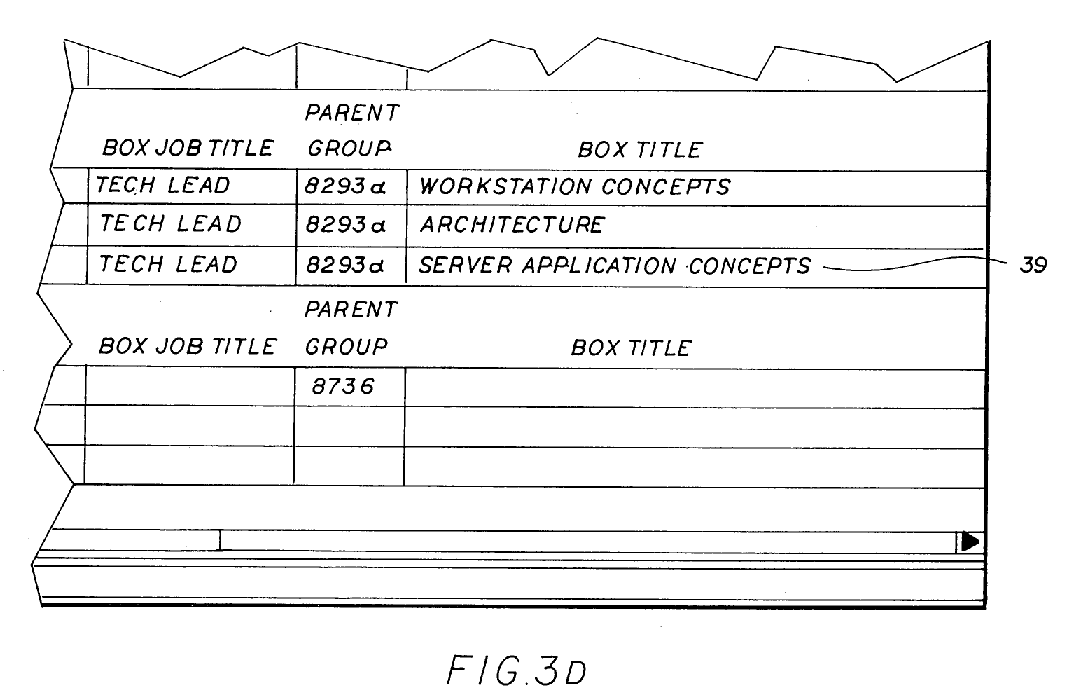

Step 10—Enter Organizational Structure. A typical management organization chart is illustrated in FIG. 2. This step defines the boxes used at the different levels of the chart using a unique group number identifier. In the example in FIG. 2, numeral 20 indicates a director's box, numeral 21 indicates a manager of multiple groups, and number 22 indicates a group level manager. This step assigns unique numbers and titles to the boxes (e.g. Web Design or Application Development) and the hierarchy of the boxes; not the employee names and attributes in or below the boxes. FIG. 3 illustrates a sample input screen where the groups (boxes) and the relationships between the groups are defined. The process of storing the group relationships as data allows the system to be easily updated should reorganization occur. Other data points in FIG. 2 include:

22, Group Leads—These are the level 4 boxes.

23, Employees—These are all employees not coded to fall into a box but fit in the organization below a box.

24, Totals Box—The upper left and right corners of the report contain various summary totals for the directorate. If all directorates have been selected then a cover page with totals for the entire organization is included in a similar format.

25, Selected Attributes—These are the attributes selected in step 13 that appear next to the name of each employee and are color coded as requested.

26, Name—The employee name, conditionally formatted as requested.

27, Legend—A footer is included to show what attributes are selected and what conditional formatting has been applied.

The computer screen in FIG. 3 includes the following data entry points for organization structure definition:

30, Standard function control buttons.

31, Group—the unique identifier number of the group.

32, Dir—the directorate code. Directorates are high level groups used for grouping and reporting. Most reports have the option to run for a single directorate or all directorates.

33, Type—Type of group. Examples are process definition, technical staff, and standard management group.

34, Lvl—The hierarchy level within the organization. 1 is always the top. 2 is always a directorate.

35, Order—This defines the print order of the boxes on the report for any given level.

36, Short Box Title—The title of the group shortened to fit in the box on the management organization chart.

37, Box Job Title—The title of the employee who normally fills the box. For example, level 2 boxes are filled by directors and level 3 boxes are filled by managers.

38, Parent Group—The group number of the box this group falls under. This is what defines the hierarchy of the organization. Reorganization would normally only require this value to be changed. This box is left blank only for the level 1 group and for any discontinued groups no longer displayed in the chart but required for historical data retention.

39, Box Title—The full group name.

It should be noted that this is not a complete management organization and is presented only for purposes of illustration.

The process continues with the following steps:

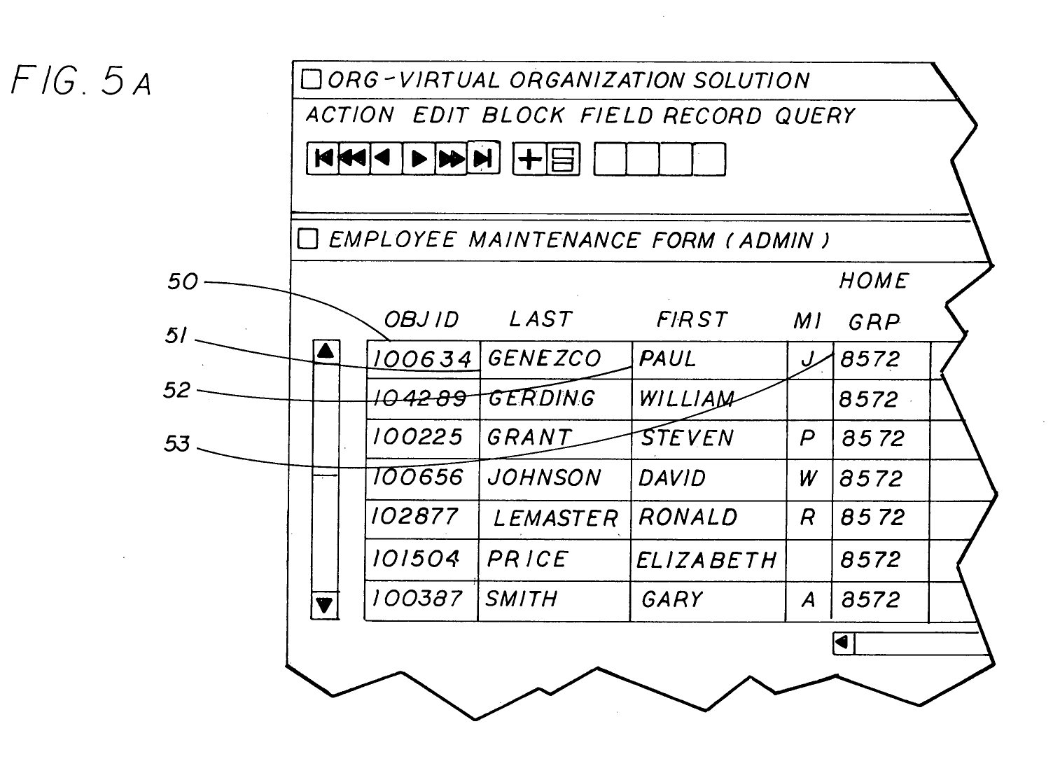

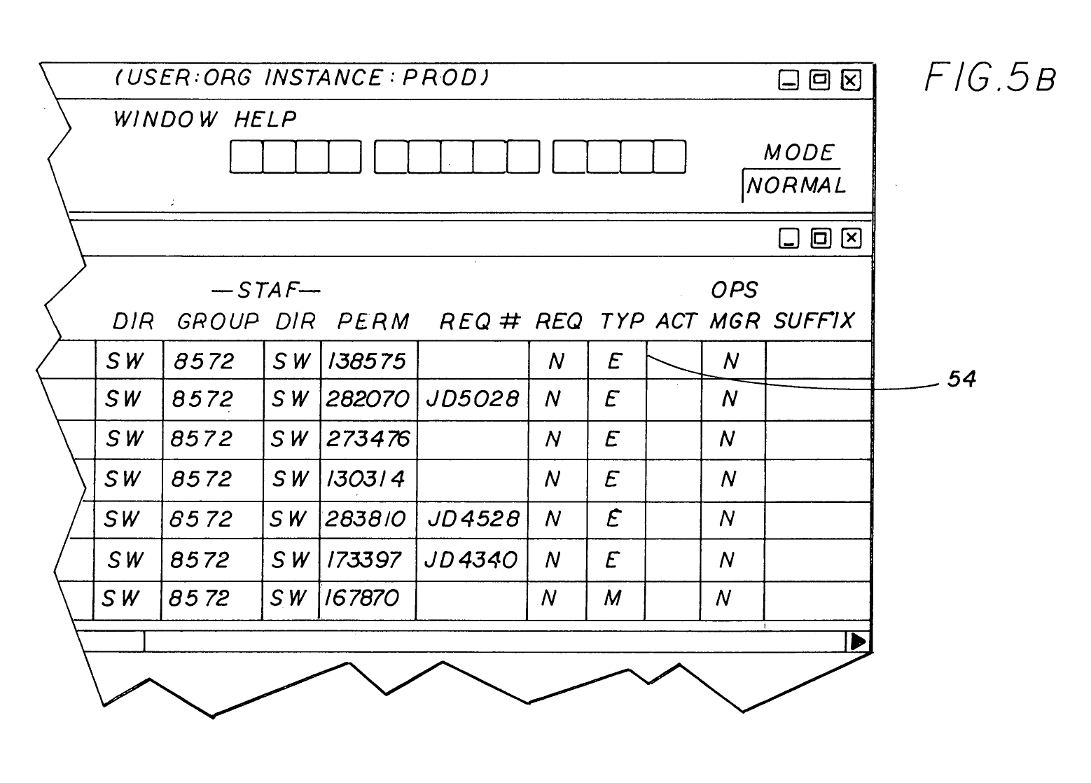

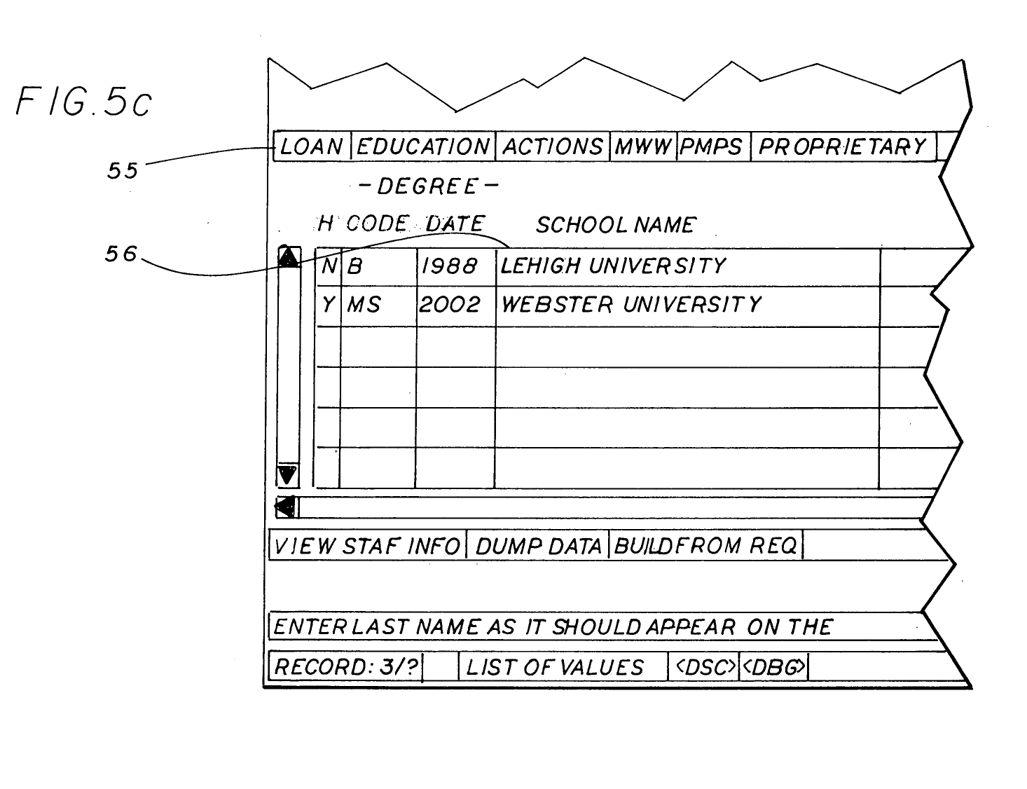

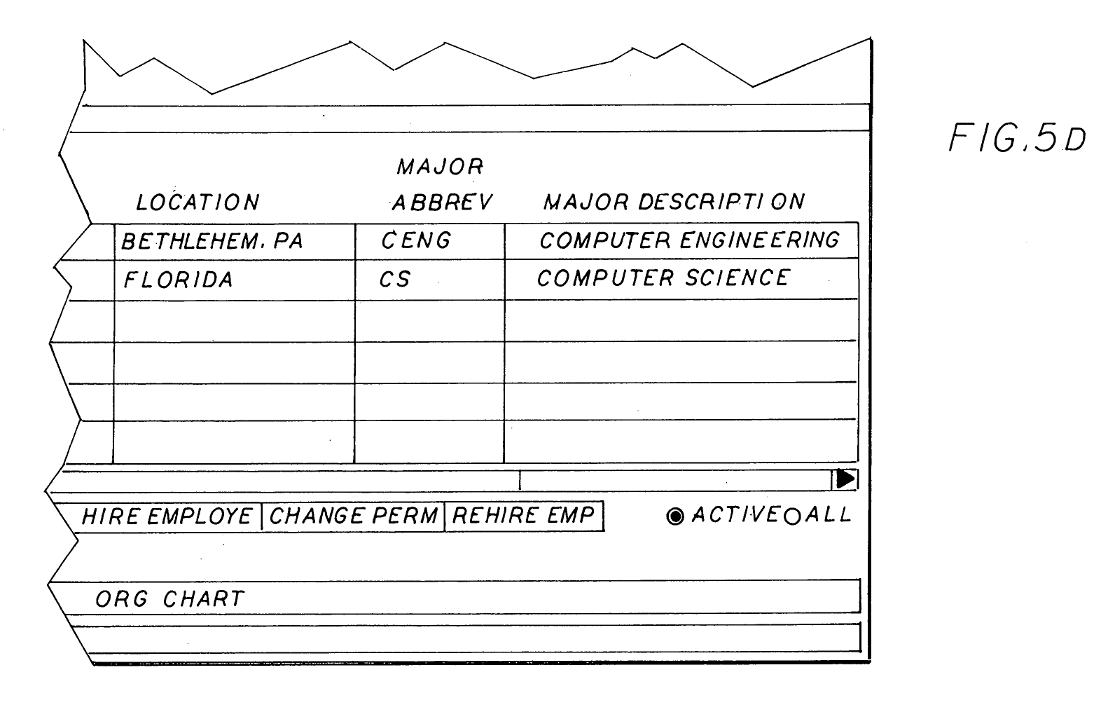

Step 44—Maintain Employees. This step maintains the employee attribute data and assigns the employees to the groups defined in step 10. FIG. 5 illustrates a sample input screen where employee data is maintained. Data entry points include, but are not limited to:

50, Obj Id—A unique identifier assigned by the system for each employee.

51, Last—The last name of the employee

52, First—The first name of the employee

53, Home Grp—The group this employee belongs to. This is the assignment of the employee to the “box” created in step 10. A cross-reference exists to ensure only valid groups may be entered.

54, Typ—This determines whether the employee goes in the box (value of M) or below the box (value of E) in the management organization chart.

55, Loan—This button allows access to a panel of information that allows an employee to be “loaned” into another group from their home group. This allows the system to handle dual assignments, temporary position changes, and other non-standard organizational changes.

56, Education—This panel allows entry of various education based attributes such as degree, year of graduation, and university name.

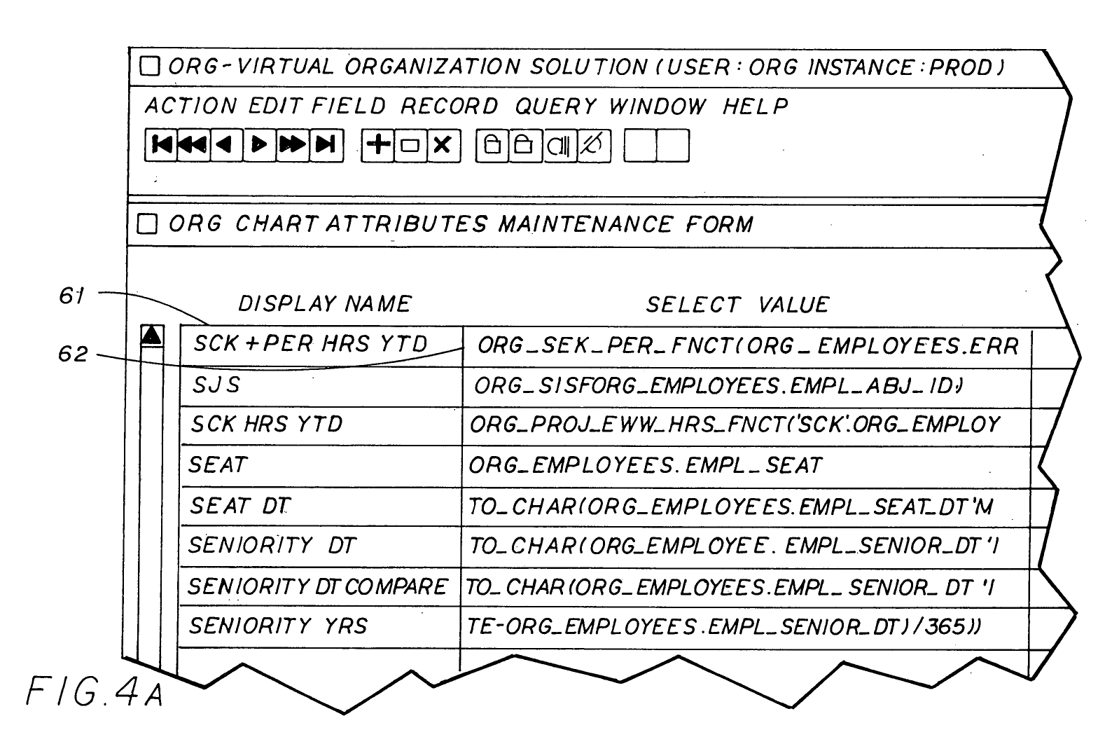

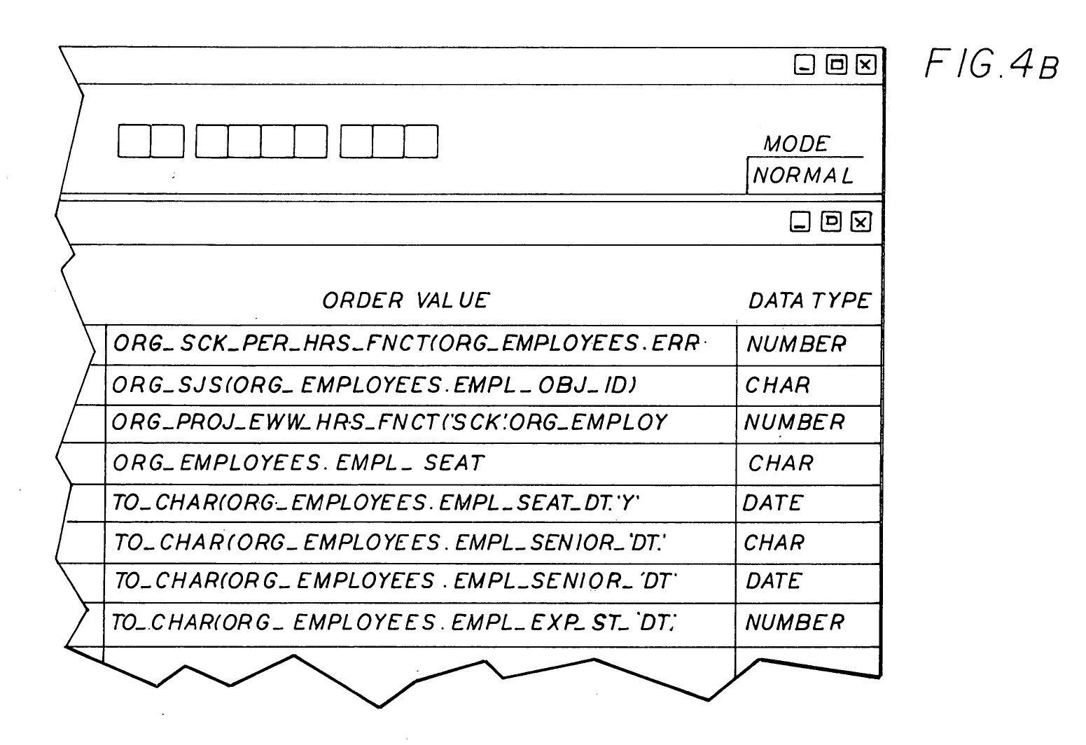

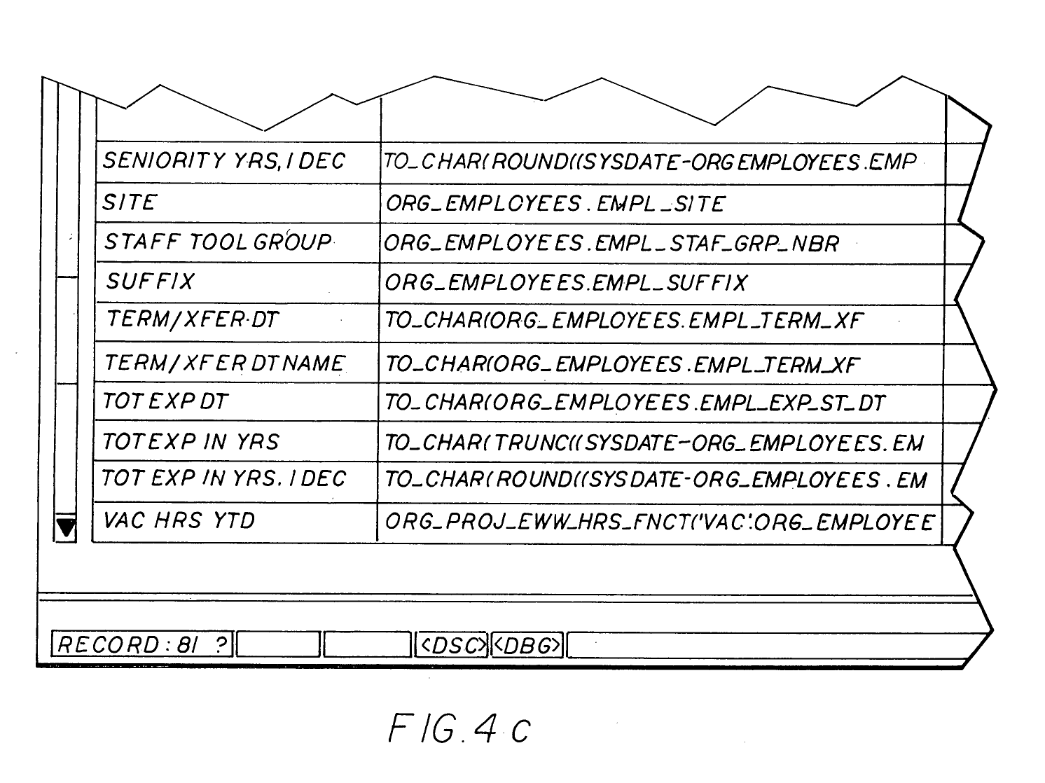

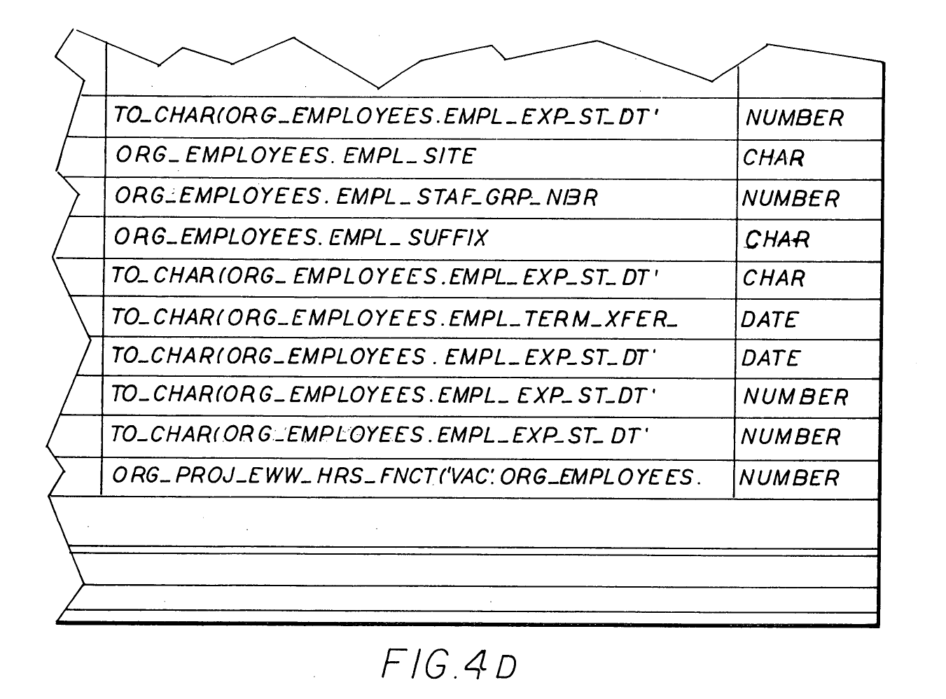

It should be noted that this is not a complete list of attributes. Many more attributes exist in the current embodiment and are constantly being added as requested. These attributes would also change from one application to another. It is the ability to so easily adapt to these changes through modification of the attribute entry screen in FIG. 5 and entries made in the attributes maintenance screen in FIG. 4 that is one of the key advantages to the system.

The process then continues with the following steps:

Step 60—Manage Report Attributes and Functions. This step maintains the attributes that are available for selection and inclusion in step 13 on the Organization Chart generated in step 75, to be subsequently discussed. FIG. 4 illustrates a sample input screen where attributes are maintained. Data entry points include, but are not limited to:

61, Display Name—The name that appears in the attribute pick list.

62, Select Value—The SQL function or Oracle table and column name used in place of this attribute if it is selected as a displayed attribute when building the SQL statement for a report.

63, Order Value—The SQL function or Oracle table and column name used in place of this attribute if it is selected as an order by attribute when building the SQL statement for a report.

64, Data Type—The data type of the value returned by this attribute. The system needs this information to perform comparisons during the color coding process.

The process then continues with the following steps:

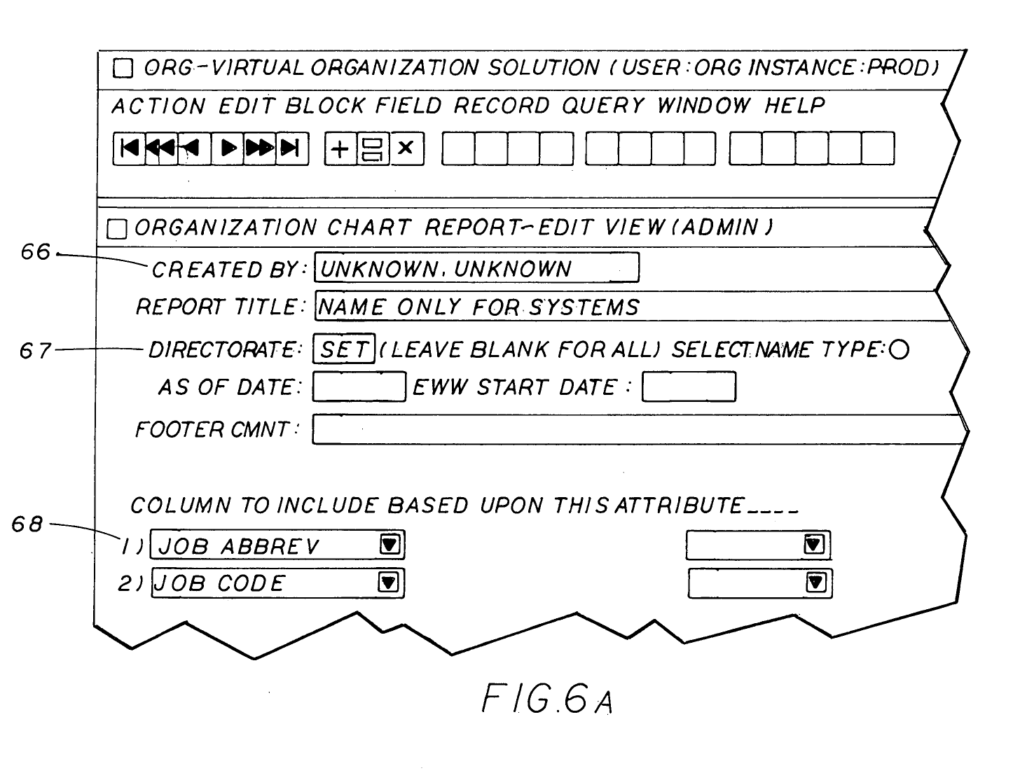

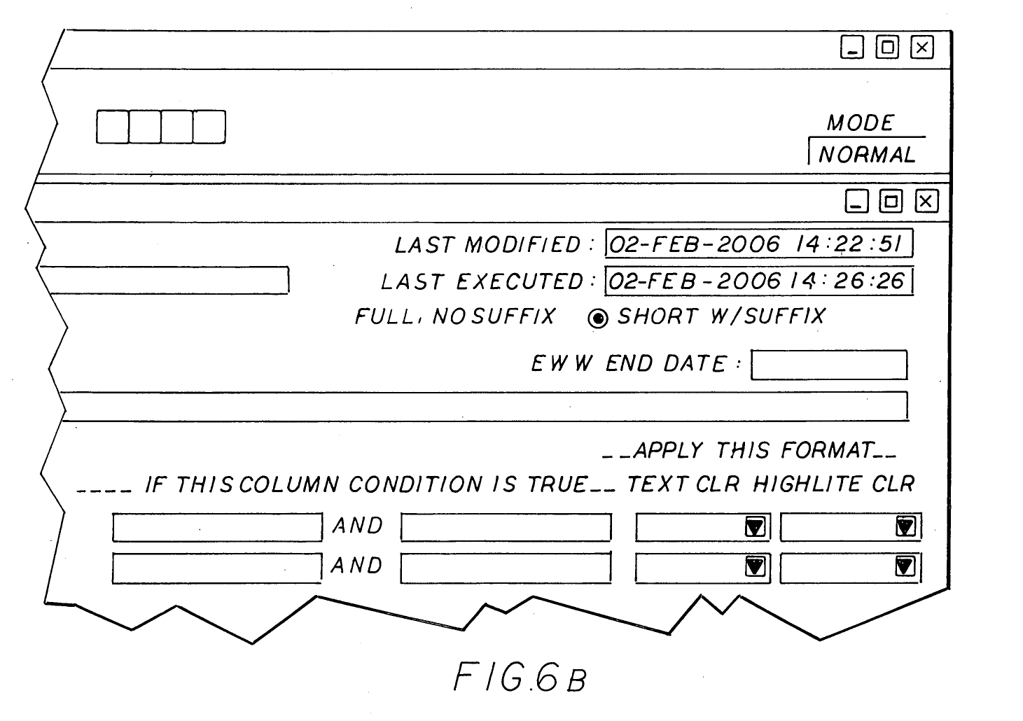

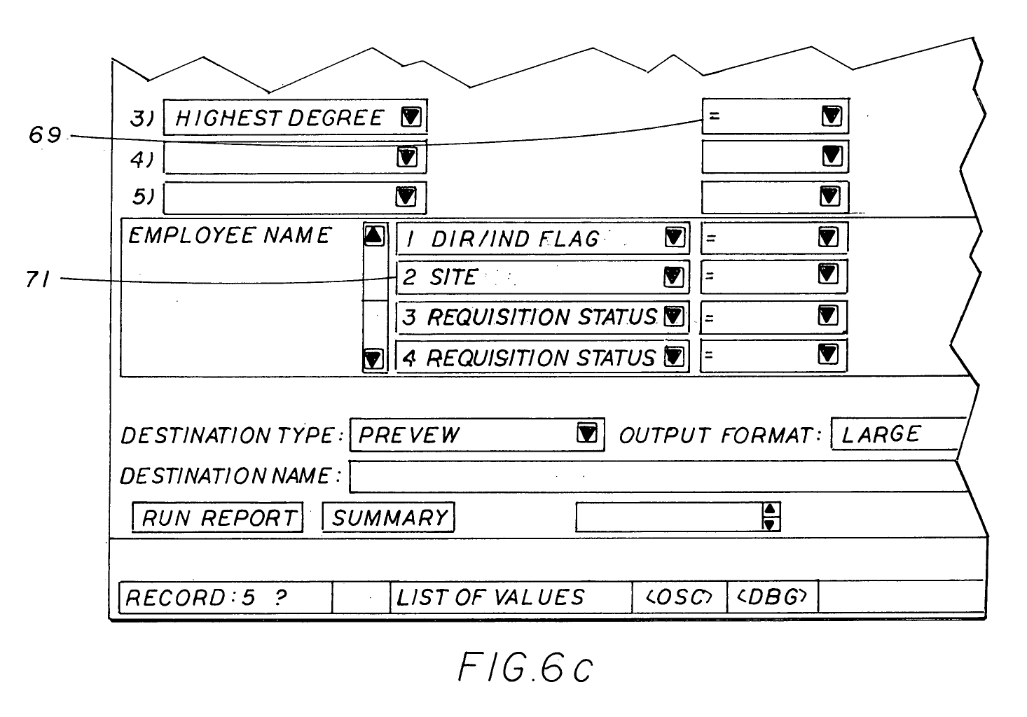

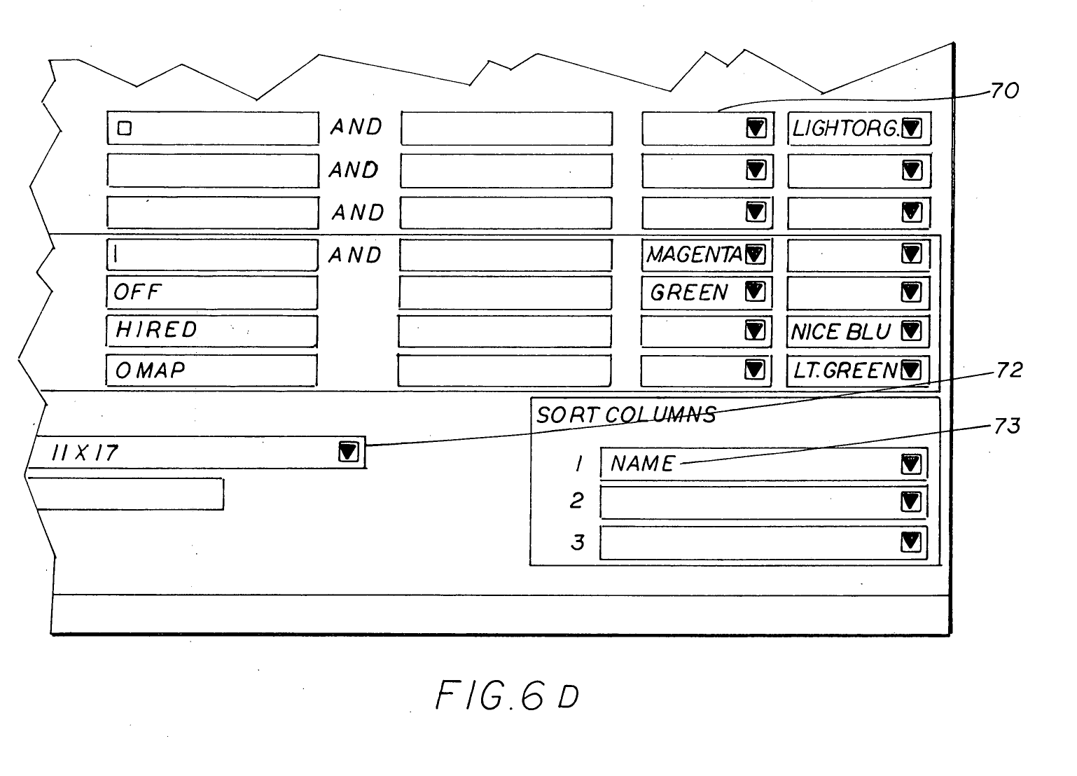

Step 65—Manage Report Definitions. This step is used to define, save, and retrieve organization chart report definitions that are then used in step 75, to be subsequently discussed. 14. FIG. 6 illustrates a sample input screen where a report definition is maintained. Data entry points include, but are not limited to:

66, Created By—The user that created this definition. Other users may copy or execute this definition, but only the creator may modify or delete the original report definition.

67, Directorate—The user has the option to run for a single directorate or leave the field blank and get a single page for all directorates and a cover page for the entire organization.

68, Column to Include—This is a pick list from all attributes defined in step 61. Selection of an attribute here makes it appear on the Organization Chart next to the employee's name.

69, Conditional expression—This is a logical operator (e.g. =, <, between) and an operator value that is checked against the value of the selected attribute when the chart is built. If the logical comparison returns true, the conditional formatting is applied to the attribute. If the operator is left blank, no conditional formatting takes place and the attribute prints as black text on white background.

70, Conditional formatting—The text color and background color may both be selected. This color format is applied if the conditional expression evaluates as true. In the figure shown, the highest degree which is selected as attribute 3 (e.g. M for masters or D for doctorate) will be given a light orange highlighted background if the value equals “D”. This creates an Organizational Chart showing each employee and their education level, highlighting those with doctorates so they can be found easily.

71, Employee Name conditional formatting—This works similar to the attribute formatting in items 69 and 70, except it is the name field that is conditionally formatted based upon any of the other available attributes. For instance the name can be highlighted red for employees with salary over a threshold or the text can be made green for employees that work at a certain location.

72, Output Format—This selected the style of the report. This includes variations in paper size, box size and color, inclusion of employee pictures for managers when available, etc. This allows the system to continually be expanded to meet new requirements.

73, Sort Columns—This is a pick list from all attributes defined in step 60. Selection of an attribute here makes the employees within a group sort by that attribute instead of the default which is by last name.

The process continues with the following step:

Step 75—Report and Review. This step takes the parameters built in step 65 and creates the Organization Chart. The processing engine merges the user's selection from step 65 with the attribute definitions from step 60 and accesses the employee data from step 44 as needed to build all the required data. It then formats that data based upon the organizational data from step 10 and the selected output requirements defined in step 65 such as output format. This Organization Chart can then be reviewed, saved, Emailed, etc. as illustrated in FIG. 2.

The use of a database management computer program such as the Oracle corporation allows organizational relationships to be easily established. A relational database works on the concept of individual objects as tables related together by primary and foreign keys and sometimes other tables forming the relationship between base objects. This mirrors the real world objects we are representing here. Groups and employees are the objects. The hierarchy of the organization and the roles of managers within the organization are the relationships. Each group references another group as its parent (group is a table, parent is a relationship). Each employee belongs to a group (employee is a table, belongs to group is a relationship). One employee in that group is the group's manager (an attribute saying “I am manager” in the employee table).

While the invention has been described with reference to a particular embodiment, it should be understood that the embodiment is merely illustrative as there are numerous variations and modifications which may be made by those skilled in the art. Thus, the invention is to be construed as being limited only by the spirit and scope of the appended claims.

### INDUSTRIAL APPLICABILITY

The invention has applicability to the computer programming industry.

1. A process for preparing management organization charts using a database management program, the process comprising the steps of:
preparing the management organization chart including the distribution of personnel in the management organization;
entering personnel attributes into the database management organization charts;
providing means for classifying groups of personnel by at least one common attribute; and
identifying the personnel in the management program by the at least one common attribute.

2. The process as set forth in claim 1 wherein said step of identifying the personnel in the management program by the at least one common attribute includes color coding the personnel having the at least one common attribute on the management organization chart.

3. A process for preparing management organization charts using a database management program, the process comprising the steps of:
defining the groups in the organization and defining the hierarchical relationships between those groups;
defining the attributes available to be reported on;
entering personnel attributes into the database;
creating a report definition to extract the desired attributes in the desired format from the database;
extracting the data in the format requested.

4. The process as set forth in claim 3 wherein said step of creating a report definition to extract the desired attributes in the desired format from the database includes the step of retrieving a dynamically selected list of attributes into a management organization chart.

5. The process as set forth in claim 4 wherein said step of retrieving a dynamically selected list of attributes into a management organization chart includes the step of selecting conditional formatting to be applied to each of the selected attributes and the name attribute which is always included.
